(19) United States
(12) Patent Application Publication
(10) Pub. No.: US 2012/0174697 A1
(43) Pub. Date: Jul. 12, 2012

(54) MOTOR VEHICLE AND ACCESSORIES THEREFOR

(76) Inventor: Wolfgang Suttner, Bielefeld (DE)

(21) Appl. No.: 12/440,521

(22) PCT Filed: Sep. 3, 2007
(86) PCT No.: PCT/EP07/07672

§ 371 Date: Aug. 13, 2009

(30) Foreign Application Priority Data
Sep. 7, 2006 (DE) 102006042497.2

(51) Int. Cl. G05G 1/40

(52) U.S. Cl. 74/513

(57) ABSTRACT

The invention relates to a motor vehicle with a control device (accelerator pedal 11), which is to be actuated by an operator and has an at least indirect influence on the torque, the acceleration or the fuel delivery rate of an engine, wherein the control device can be actuated against the force of at least one return means (16, 18). According to the invention a return means (18) having an adjustable force is provided.

### STATEMENT OF RELATED APPLICATIONS

This application is the U.S. National Phase Under Chapter II of the Patent Cooperation Treaty (PCT) of PCT International Application No. PCT/EP2007/007672 having an International Filing Date of 3 Sep. 2007, which claims priority on German Patent Application No. 10 2006 042 497.2 having a filing date of 7 Sep. 2006.

### BACKGROUND OF THE INVENTION

1. Technical Field

The invention relates to a motor vehicle with a control device, which is to be actuated by an operator and has an at least indirect influence on the torque, the acceleration or the fuel delivery rate of an engine, wherein the control device can be actuated against the force of at least one return means. The invention further relates to an accessory for a motor vehicle with an accelerator pedal. The accessory may also be a foot mat with return means.

2. Related Art

As a control device automobiles have an accelerator pedal, which is operated by the driver with the foot against the action of a return force. Other vehicles may have similar control devices to be actuated by an operator.

The energy consumption for powering the vehicle varies at least indirectly as a function of the extent to which the control device is actuated or the movement of the accelerator pedal. The further this is depressed towards the floor pan of the vehicle, the more energy is expended in order to power the vehicle.

A mode of driving in which the accelerator pedal is not actuated right down to the limit stop for driving off or acceleration is especially economic, particularly in the case of high-capacity internal combustion engines. Higher engine speeds with unfavorable specific energy consumption and increased tire wear are thereby avoided. High-performance engines sometimes tempt the driver, even in urban driving, to exceed the admissible top speed when accelerating. This can also occur due to fleeting carelessness.

The driver can avoid the aforementioned disadvantages if he concentrates on the operation of the control device or accelerator pedal, for example in conjunction with observance of the fuel consumption indicator. This is irksome and also not always feasible, since driving in traffic normally demands the driver's full attention.

### BRIEF SUMMARY OF THE INVENTION

The present invention is intended to provide the operator with an aid to limiting the energy consumption when actuating the control device.

The motor vehicle according to the invention is characterized by a return means having an adjustable force. The control device or accelerator pedal is usually moved by the operator against the return force of the return means. Basically the control device should be easily actuated, in order to make operation easier for the driver. According to the invention the return force of the return means is now adjustable, in order to temporarily oppose the force applied by the operator with a greater force. Given a higher return force, the operator will spontaneously avoid heavier actuation of the control device and will thus automatically achieve a lower energy consumption when accelerating. The adjustment of the return force should preferably be undertaken by the operator himself.

The adjustable return means is advantageously provided in addition to a further return means. An accelerator pedal of a motor vehicle usually has a return spring, which in this case is regarded as a further return means. The adjustable return means is then provided in addition. The return forces of the adjustable return means and the further return means are cumulative.

According to a further idea of the invention the adjustable return means only comes into effect once the control device has overcome a certain travel or angle against the return force of the further return means. This means that initially only the return force of the further return means is operative. Only after more extensive actuation of the control device does the return force of the adjustable return means supervene. As a result the operator is given the impression of a sudden increment in the return force when accelerating. The adjustable return means is capable of varying this sudden force increment or even reducing it to zero, so that only the return force of the further return means is operative. The sudden force increment that occurs indicates to the operator that the actuation of the control device might be economically appropriate only up to this point. Alternatively or in addition, the location of the sudden force increment along the actuating travel of the control device is preferably adjustable via the adjustable return means.

An actuating device to be actuated by the operator for adjusting the adjustable return means is advantageously provided. The operator thus has full control over the working of the adjustable return means and can adjust this to his individual requirements.

According to a further idea of the invention the adjustable return means contains a volume of fluid, in particular a compressible volume of gas. This is preferably air. The volume of gas acts as a spring countering the actuation of the control device. The pressure of the volume of fluid, in particular the volume of gas in the adjustable return means, is preferably adjustable. Alternatively or in addition the volume may be increased by inflation or admission of the fluid or may, if necessary, be discharged.

According to a further idea of the invention the adjustable return means or a volume connected thereto has a pressure-relief valve. On attainment of a specific pressure in the volume of gas, the pressure-relief valve opens, thereby preventing any further increase in the return force. This facilitates operation of the control device in extreme situations, as is the case when sharp acceleration suddenly becomes necessary.

The adjustable return means advantageously contains a fluid reservoir with flexible, in particular elastic walls, that is to say elastic in the direction of the walls themselves. The control device acts on at least one of the walls. The effective return force varies as a function of the fluid pressure, in particular the gas pressure and/or the deformation of the walls of the reservoir. The reservoir is preferably of the cushion or balloon type and made, in particular, from latex, rubber or rubber-like material or from a woven fabric with a fluid-tight, in particular a gas-tight finish, similar to the cuff of a sphygmomanometer.

The return force may be generated by the fluid, for example by a compressible gas, in particular air. The gas reservoir may then have inelastic walls. The return force results from the compression of the gas. Where a liquid is used, the walls of the fluid reservoir are preferably elastic. The return force then results from the elastic dilation of the reservoir walls. However, a gas reservoir may also have elastically dilatable walls.

According to a further idea of the invention the adjustable return means is a fluid-filled cushion, which is of at least double-walled design, that is to say formed with an inner casing and an outer casing. This affords increased safety against incursive influences of all kinds. In this case the inner casing may have elastically dilatable walls and the outer casing may have non-dilatable walls. Elastically dilatable and at the same time fluid-tight material may be susceptible to the effect of sharp-pointed objects, corners, edges etc. The outer casing is made from material that is by comparison more robust, for example from the material used for truck tarpaulins, and thus effectively protects the elastic inner casing.

According to a further idea of the invention the adjustable return means is connected via a line to a fluid source, in particular a gas source. The latter is preferably an air pump, which acts as actuating device for the adjustable return means. A rubber ball like that in a sphygmomanometer with cuff, for example, is provided as air pump.

According to a further idea of the invention the adjustable return means or a volume connected thereto has a pressure display. The pressure display is preferably arranged on the actuating device. The pressure display may be a pressure gauge or a more simple display for the operator.

According to a further idea of the invention the adjustable return means or a volume connected thereto has an actuatable outlet valve. The pressure of the volume of gas can be controlled by the outlet valve or reduced in a very brief time, in particular by the operator.

According to a further idea of the invention the fluid source may be located on the return means or may be incorporated into the latter. This avoids the need for a longer line between the fluid source and the return means.

A remote control, in particular a radio or cable remote control, is advantageously provided for the fluid source. A radio connection is possible, for example, via Bluetooth or another short-range radio system. An infrared connection is also possible. The fluid source then preferably has a remotely controlled valve or pump.

According to a further idea of the invention an air pump is arranged on the return means as fluid source or is incorporated into the return means, particularly with an electrical drive and preferably with a radio receiver for receiving signals for the activation of the air pump drive. An energy storage device for the electrical drive, in particular batteries or accumulators, may likewise be located on the return means. In this case a remote control by radio, cable or other means is also possible. The energy storage device may also be located at a distance from the fluid source or the return means. The electrical energy is then transmitted by cable to the drive. A cable remote control is also possible. The energy storage device may then be provided either in the remote control, on the return means or elsewhere.

The invention described above can also be provided as an accessory for a motor vehicle with an accelerator pedal. The accessory then comprises at least one return means for the accelerator pedal, a return force of the return means being adjustable. The accessory is intended particularly for retrofitting to the motor vehicle.

Fasteners and retainers are advantageously provided for locating the return means in a space behind the accelerator pedal, preferably on the accelerator pedal. In particular the retainers are designed in such a way that it is possible to fix the return means between the accelerator pedal and the floor pan or adjoining wall of the motor vehicle. It is also feasible to attach the return means to the accelerator pedal, to the floor pan or to another footwell wall.

The invention also relates to an accessory for a motor vehicle with an accelerator pedal, having the following features:
a) fasteners or retainers for locating the accessory in the footwell of the motor vehicle, in particular between the accelerator pedal and the footwell wall or the floor pan.
b) a return means for the accelerator pedal, the return means being provided in addition to a return means that is ordinarily associated with the accelerator pedal anyway.

A return force of the return means operative over a part of the actuating travel of the accelerator pedal is advantageously adjustable. In addition the invention may be combined as an accessory with all features and configurations according to the invention that have previously been specified and are specified below.

The return means with or without remote control or other constituent parts can also be incorporated into a foot mat or fixedly or detachably connected to the latter. The invention accordingly also relates to a return means associated with a foot mat and a foot mat having such return means.

The return means associated with the foot mat is advantageously elastically deformable by the pressure of the accelerator pedal. In particular the return means contains a cushion, such as an air cushion, filled with a fluid. The return means may naturally also have the features and functions specified above. Associating the return means with the foot mat avoids any additional fixing of the return means to the accelerator pedal or another site in the footwell of the motor vehicle. All that is required is a precise positioning of the foot mat. In modern vehicles, however, this is ensured by fixing points for the foot mat. Alternatively or in addition the foot mat according to the invention may comprise its own fasteners, for example Velcro strips, adhesive tapes or clips, for securing a defined position in the footwell.

### BRIEF DESCRIPTION OF THE DRAWING FIGURES

Further features of the invention are set forth in the claims and elsewhere in the description. Advantageous exemplary embodiments of the invention are explained in more detail below with reference to the drawings, in which:

FIG. 1 shows a schematic representation of a footwell in a motor vehicle with an accelerator pedal and floor pan and return means,

FIG. 2 shows a representation similar to FIG. 1, but with another embodiment of a return means,

FIG. 3 shows a travel-force diagram to explain the sudden force increment due to the return means,

FIG. 4 shows a top view of a cushion-like return means,

FIG. 5 shows a cross section through the cushion according to FIG. 4 along the line A-A,

FIG. 6 shows a cross section similar to FIG. 5, in a different embodiment,

FIG. 7a shows a schematic drawing of a return means with remote control,

FIG. 7b shows a representation similar to FIG. 7a, of another embodiment,

FIG. 7c shows a representation similar to FIG. 7a, of a further embodiment,

FIG. 8 shows a top view of a foot mat with return means,

FIG. 9 shows a top view of another embodiment of a foot mat with return means.

### DETAILED DESCRIPTION OF PREFERRED EMBODIMENTS

An accelerator pedal 1 as control device is swivel mounted about a lower pivot point 12 in the footwell 10 of a motor vehicle 10. The swivel movement of the accelerator pedal 11 initiated by a driver as operator is represented by the arrow 13.

The pivot point 12 is situated on a floor pan 14. A wedge-shaped gap, in which the accelerator pedal 11 can be moved to and fro, is formed between the accelerator pedal 11 and a footwell wall 15, adjoining the floor pan 14 and oriented obliquely upwards. When the accelerator pedal 11 is moved in the direction of the arrow 13, that is to say towards the footwell wall 15, the driver must overcome the return force of a return means 16, which takes the form of a compression spring, for example.

A stop 17, towards which the accelerator pedal 11 is maximally moveable, is arranged on the footwell wall 15, so that even when the accelerator pedal 11 is fully depressed a residual gap remains between the accelerator pedal 11 and the footwell wall 15.

An adjustable return means 18, which is here embodied as a cushion-shaped compressed air accumulator, is arranged in the gap between the accelerator pedal and the footwell wall 15 in addition to the return means 16. The adjustable return means 18 is preferably attached either to the footwell wall 15 or to the accelerator pedal 11. The attachment is not shown in the drawings. For example, the return means 18 is connected to the footwell wall 15 by a Velcro strip connection (not shown). A corresponding Velcro tape may be bonded onto the footwell wall 15. The return means 18 then has a corresponding Velcro tape. The adjustable return means 18 may also be attached to the accelerator pedal 11, for example by a strap, a Velcro tape, hooks, clips and the like, which are not shown.

The dimension of the adjustable return means 18 parallel to the direction of the arrow 13 here also varies as a function of the pressure and is preferably always less than the maximum distance of the accelerator pedal 11 from the footwell wall 15. As a result, the adjustable return means 18 only comes into effect once the accelerator pedal 11 has been moved by a certain travel or angle from the starting position shown in the drawings.

The adjustable return means 18 is connected by a pressure line 19 to an actuating device 20 to be actuated by the driver. In the present example this is embodied as an air pump in the nature of a rubber ball, as in a sphygmomanometer. Actuation of the rubber ball causes air to be pumped into the adjustable return means 18, where it increases the internal pressure and thereby increases the return force exerted by this on the accelerator pedal 11.

For this purpose a fitting 21 with an outlet valve 22 and an actuating element 23 is assigned to the actuating device 20. Also connected to the fitting 21 is a pressure display instrument 24, such as a pointer pressure gauge.

The actuating device 20 may be located in the interior of the vehicle at a point easily accessible and visible to the driver, for example at or on a center console or between the center console and the driver's seat or close to a gearshift lever. The pressure line 19 is configured and laid accordingly.

By actuating the device 20 and the actuating element 23 the driver can individually set the pressure in the adjustable return means and/or the effective thickness thereof and adjust them to the traffic conditions, for example.

A pressure relief valve 25 is here also assigned to the adjustable return means 18. This valve prevents a destructive excess pressure in the adjustable return means 18 even under strong actuation of the accelerator pedal 11 and at the same time limits the effective return force.

The stop 17 prevents the adjustable return means 18 being excessively compressed by the accelerator pedal 11.

The means for transmitting the accelerator pedal movement to an engine control system of the motor vehicle are not shown in the drawings. These means are known and do not require further explanation. For example, a lever mechanism or linkage may be provided.

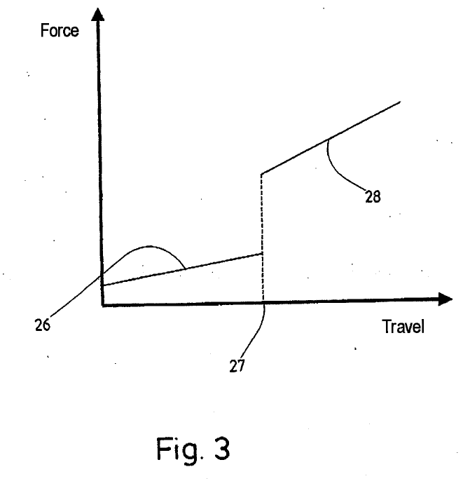

FIG. 3 shows the aggregate return force occurring in the actuation of the accelerator pedal 11. Over an initial travel or angle or section only the return force 26 of the return means 16 is operative. As soon as the accelerator pedal 11 is moved somewhat further, that is to say beyond a threshold 27, the return force of the adjustable return element 18 takes additional effect. This causes a resulting return force 28. At the threshold 27 a sudden force increment occurs, which is clearly perceived by the driver in the actuation of the accelerator pedal 11 and which, depending on the magnitude of the sudden force increment, can lead to the accelerator pedal 11 being actuated only as far as the threshold 27.

The lengths of travel of the two sections before and after the sudden force increment are divided over the total possible movement of the accelerator pedal 11 in a ratio of 1/3 to 2/3, 1/2 to 1/2 or 2/3 to 1/3, for example. Other travel ratios are possible and can easily be configured and even adjusted through corresponding configuration of the return means 18. The first section may also have a zero length.

With the outlet valve 22 opened, the return force of the adjustable return means 18 is minimal and even equal to zero. The resulting return force 28 is then equal to the return force of the return means 16, so that no sudden force increment occurs at the threshold 27.

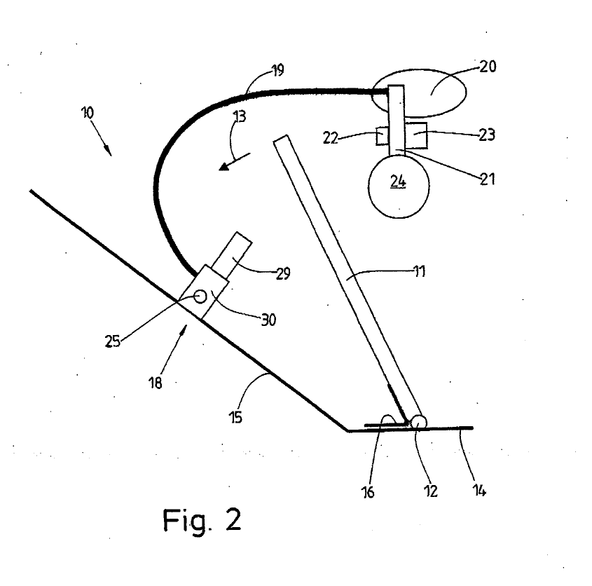

FIG. 2 shows an alternative embodiment of the return means 18, that is to say a piston-cylinder arrangement with a piston 29 that can be extended from a cylinder 30. The cylinder 30 is here fixed on the footwell wall 15, so that the piston 29 can be extended counter to the direction of the arrow 13. Inversely it is also possible to attach the cylinder 30 to the accelerator pedal 11 or to transpose the cylinder and the piston.

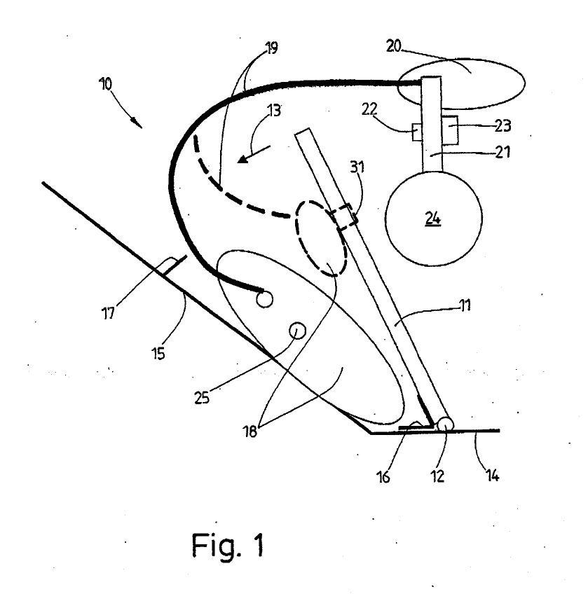

The pressure line 19 is connected to the cylinder 30. In addition the cylinder 30 has the pressure-relief valve 25. A stop corresponding to the stop 17 in FIG. 1 is not necessary here, since the working of the cylinder 30 and the piston 29 already affords a stop for the accelerator pedal 11.

In the fully extended position of the piston 29, as shown in FIG. 2, there is a distinct space between it and the accelerator pedal 11 (in its zero position). On actuation of the accelerator pedal 11 it is initially only necessary to overcome the return force of the return means 16. Only on reaching the piston 29 does this also act as (adjustable) return means. However, the space is not obligatory.

The cylinder 30 is preferably attached to the footwell wall 15, by bolting, welding, riveting or adhesive bonding.

A return spring may be integrated into the piston-cylinder arrangement, so that the already extended position of the piston varies and can be adjusted as a function of the gas pressure. An embodiment without a spring is also possible, which means that the piston, even under a slight pressure, always assumes the same limit position, at which the sudden force increment is also perceptible to the driver.

The adjustable return means 18 may also be held on the underside of the accelerator pedal 11. This alternative is represented by dashed lines in FIG. 1. The return means 18 in this embodiment is a cushion or balloon, which is held by a fastener, that is in this case by a band or tape 31 drawn over the accelerator pedal 11.

In the simplest embodiment the return means 18 is not adjustable and merely supplements return means 16 that is ordinarily associated with the accelerator pedal 11 anyway. This then results, over a first part of the actuating travel of the accelerator pedal, in a return force deriving solely from the return means 16. Only over a succeeding part of the actuating travel of the accelerator pedal 11 is the return means 18 additionally operative. Where the return means 18 is not adjustable, the succeeding actuation travels and the point of the sudden force increment will vary solely as a function of the thickness of the return means 18 and the space that exists between the accelerator pedal 11 and the floor pan 14 or footwell wall 15.

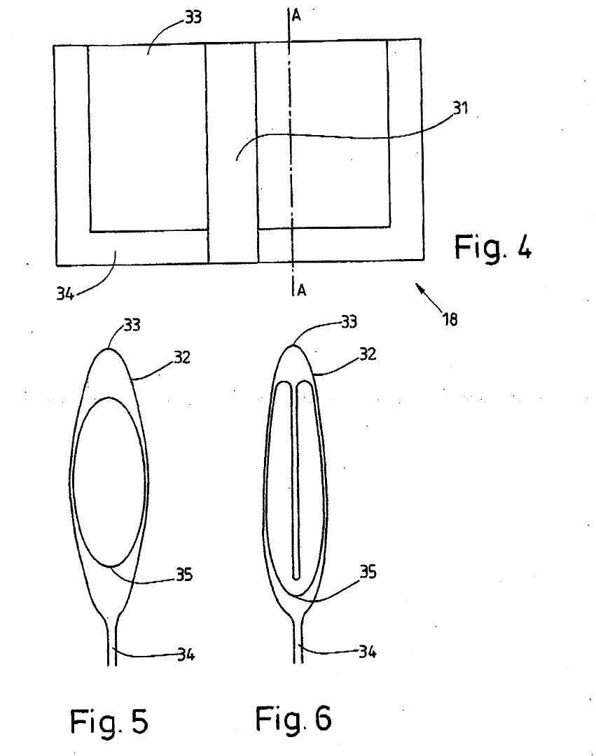

According to FIGS. 4 to 6 the cushion-like return means 18 is of special, double-walled design. An outer casing 32 is formed by folding along a fold line 33 and a substantially U-shaped fin seam 34. The outer casing is composed of a material that is as resistant as possible to mechanical stresses, friction and sharp objects, such as the material used for truck tarpaulins, which is a tear-resistant woven fabric with waterproof coating. An adhesive bond or weld may be provided in the area of the fin seam 34.

An inner casing 35, which serves as fluid accumulator and is here composed of an elastically dilatable material, such as rubber, latex or the like, is arranged inside the outer rectangular casing 32. For reasons of clarity, connections or lines for the delivery of a fluid into the inner casing 35 are not drawn in FIGS. 4 to 6.

The dimensions and volumes of the outer casing 32 and the inner casing 35 are matched to one another so that a fluid flowing into the inner casing 35 here produces a greater thickness of the return means 18 and a higher return force. According to FIG. 5 the inner casing 35 is distinctly smaller than the outer casing 32. This allows the inner casing 35 to expand significantly inside the outer casing 32 and with full pressure exerted on the accelerator pedal, for example, to yield almost completely to the reduction of the thickness.

In the embodiment in FIG. 6 the inner casing 35 is folded once. As a result more dilatable wall material is available, so that the elastic wall of the inner casing 35 experiences a lower expansion stress overall.

On its upper side the cushion-shaped return means 18 has the tape 31 for attachment to the accelerator pedal. The tape 31 may be a rubber band, an elastic fabric band, a Velcro strip or the like. Alternatively clips or hooks may also be provided for attachment to the accelerator pedal.

The action and working of the cushion-like return means 18 also depend on the ratio between the size of the return means and the size of the accelerator pedal. A return means 18 protruding laterally or at the end of the accelerator pedal allows a residual volume in the return means 18 outside the range of action of the accelerator pedal. A virtually full depression of the accelerator pedal can thus be achieved more easily despite the presence of the return means 18.

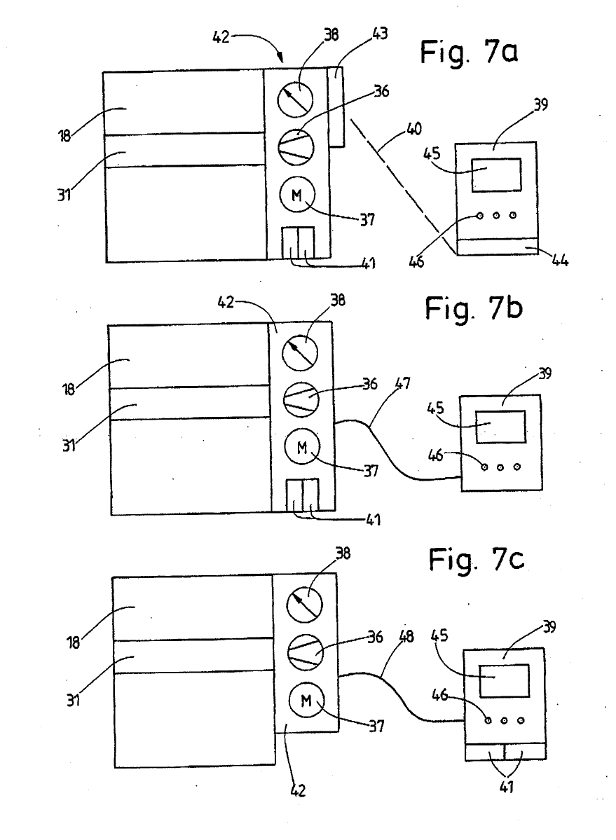

FIGS. 7a to 7c show the return means 18 as an air cushion with integral electrical air pump 36, the drive motor 37 for this, the pressure gauge 38 and the remote control 39. Widely varying combinations are possible here. FIGS. 7a to 7c show only three selected exemplary embodiments:

According to FIG. 7a the return means 18 and the remote control 39 are coupled together via a radio connection 40 drawn in dashed lines.

In the exemplary embodiment in FIG. 7a the pressure gauge 38, the air pump 36, the electric motor 37 and accumulators 41 are combined into one functional unit 42, which is arranged immediately next to the return means 18, for example at the side of it.

An integral part of the functional unit 42 in this case is a transmitter and receiver unit 43, which is in wireless communication with a corresponding transmitter and receiver unit 44 of the remote control 39.

The remote control 39 has a display 45 and operating elements 46, for example, pushbuttons. Any accumulators or batteries present are not drawn in.

The remote control 39 controls the drive of the motor 37 for the air pump 36 and possibly an outlet valve (not shown) in the functional unit 42. Operating states of the motor 37, the filling level of the accumulators 41 and/or the pressure determined by the pressure gauge 38 may be displayed on the display 45, depending on the equipment and range of functions.

In an especially simple embodiment the unit 44 is embodied only as a transmitter unit and the unit 43 solely as a receiver unit. A pressure gauge is then not required.

In the embodiment according to FIG. 7b the remote control 39 and the functional unit 42 of the return means 18 are connected together by an electrical cable. This is preferably just a data cable 47, so that the transmitter and receiver units 43, 44 are not needed. Otherwise it largely conforms to the exemplary embodiment in FIG. 7a.

FIG. 7c shows a modification of the cable-connected exemplary embodiment. The cable between the functional unit 42 and the remote control 39 is here embodied as a combined power and data cable 48. As energy-storage device for powering the motor 37, the accumulators 41 are integrated not into the functional unit 42 but into the remote control 39.

The functional unit 42 may be designed separately from the return means 18 and may be held in the footwell of the vehicle. There is then at least one air line between the air pump 36 and the return means 18 (not shown). As an extension of this idea, the functional unit 42 may also be part of the remote control 39 with a correspondingly longer air line.

The operating elements 46 may be designed, for example, so that at the press of a button previously defined and stored values are set. Alternatively or in addition, selected operating elements may have the functions “increase pressure” and/or “reduce pressure”.

In an embodiment not shown similar to that in FIG. 7a, the function of the remote control 39 is assumed by a mobile phone with Bluetooth facility or by another unit with Bluetooth facility arranged in the vehicle.

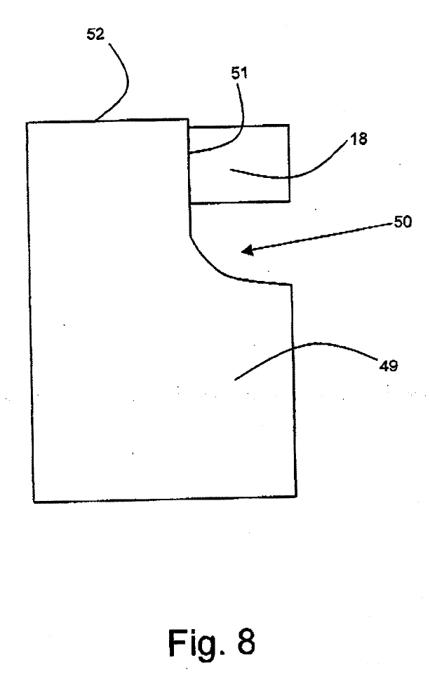

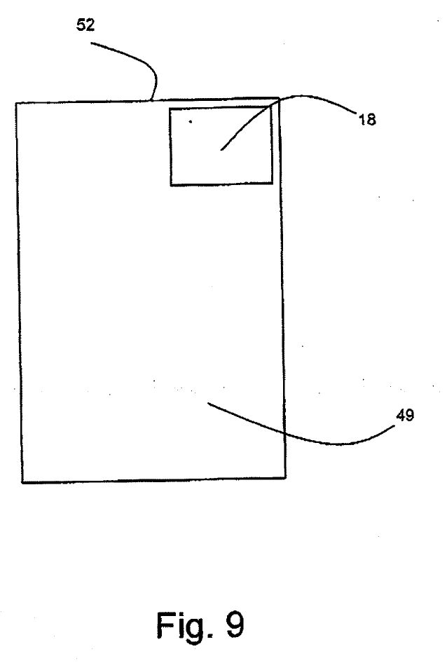

In the embodiment in FIGS. 8 and 9 the return means 18 is connected to a foot mat 49 or is incorporated into the latter. A foot mat in front of the driver's seat usually has a recess 50 for the accelerator pedal, at any rate where the accelerator pedal is pivoted at its lower end. This embodiment is shown in FIG. 8.

The return device 18 is located in the area of one edge 51 of the recess 50 and at the same time only a short distance from the upper edge 52 of the foot mat. The return means 18 is preferably bonded, stitched, welded or otherwise connected laterally to the foot mat 49, depending on the type of materials used. At the same time the return means may be embodied as previously explained with reference to FIGS. 1 to 7c or embodied in some other way. The important thing is that the return means exerts a return force in opposition to the pressure exerted on the accelerator pedal by the driver. The return force may be variable according to the height and/or the location or it may be constant.

According to FIG. 9 the foot mat 49 has no recess in the top right-hand corner. This configuration is possible in the case of an accelerator pedal pivoted outside the area of the foot mat (for example at the top). The return means 18 is then located on the top right-hand side of the foot mat or is incorporated into this, so that with correct positioning of the foot mat the return means comes to lie under the accelerator pedal.

The other elements and components associated with the return means 18, in particular the parts of the functional unit represented in FIGS. 7a to 7c (reference numerals 36, 37, 38, 41, 43), can also be incorporated into the foot mat 40 or connected thereto.

The design of the foot mat 49 and the arrangement of the return means 18 against or on the foot mat depend on the spatial proportions of the footwell in the particular vehicle and must be adapted accordingly. The same applies to an instance in which the accelerator pedal is arranged on the left-hand side of the footwell rather than the right-hand side.

### LIST OF REFERENCE NUMERALS

10 footwell
11 accelerator pedal
12 pivot point
13 arrow
14 floor pan
15 footwell wall
16 return means
17 stop
18 adjustable return means
19 pressure line
20 actuating device
21 fitting
22 outlet valve
23 actuating element
24 pressure display
25 pressure-relief valve
26 return force
27 threshold
28 resulting return force
29 piston
30 cylinder
31 tape
32 outer casing
33 fold line
34 fin seam
35 inner casing
36 air pump
37 electric motor
38 pressure gauge
39 remote control
40 radio connection
41 accumulators
42 functional unit
43 transmitter and receiver unit
44 transmitter and receiver unit
45 display
46 operating elements
47 data cable
48 power and data cable
49 foot mat
50 recess
51 edge of recess
52 top edge

1. A motor vehicle with a control device, which is to be actuated by an operator and has an at least indirect influence on the torque, the acceleration or the fuel delivery rate of an engine, wherein the control device can be actuated against the force of at least one return means (16, 18), the control device comprising a return means (18) having an adjustable force.

2. The motor vehicle as claimed in claim 1, wherein the adjustable return means (18) is advantageously provided in addition to a further return means (16).

3. The motor vehicle as claimed in claim 2, wherein the adjustable return means (18) only comes into effect once the control device has overcome a certain travel or angle against the return force of the further return means (16).

4. The motor vehicle as claimed in claim 1, further comprising an actuating device to be actuated by the operator for adjusting the adjustable return means (18)

5. The motor vehicle as claimed in claim 1, wherein the adjustable return means (18) contains a volume of fluid.

6. The motor vehicle as claimed in claim 5, wherein the pressure of the volume of fluid is adjustable.

7. The motor vehicle as claimed in claim 5, wherein the adjustable return means (18) or a volume connected thereto has a pressure-relief valve (25).

8. The motor vehicle as claimed in claim 1, wherein the adjustable return means (18) contains a fluid reservoir with flexible walls, which are elastic particularly in a plane direction in the direction of the walls themselves.

9. The motor vehicle as claimed in claim 5, wherein the adjustable return means (18) is connected via a line (19) to a fluid source.

10. The motor vehicle as claimed in claim 9, wherein the fluid source is a gas source, which is an air pump.

11. The motor vehicle as claimed in claim 5, wherein the adjustable return means (18) or a volume connected thereto has a pressure display (24).

12. The motor vehicle as claimed in claim 5, wherein the adjustable return means (18) or a volume connected thereto has an actuatable outlet valve (22).

13. An accessory for a motor vehicle with an accelerator pedal (11), comprising:
a) at least one return means (18) for the accelerator pedal (11), and
b) a return force of the return means (18) is adjustable.

14. The accessory as claimed in claim 13, further comprising fasteners or retainers for locating the adjustable return means (18) in a space behind the accelerator pedal (11).

15. The accessory as claimed in claim 13, wherein the adjustable return means (18) has a volume of fluid, on which the accelerator (11), when actuated, impinges.

16. The accessory as claimed in claim 13, wherein the adjustable return means (18) is a cushion filled with a fluid, the cushion having elastically dilatable walls.

17. The accessory as claimed in claim 13, wherein the adjustable return means (18) is a fluid-filled cushion, which is of at least double-walled design having an inner casing (35) and an outer casing (32).

18. The accessory as claimed in claim 17, wherein the inner casing (35) has elastically dilatable walls and the outer casing (32) has non-dilatable walls.

19. The accessory as claimed in claim 15, wherein the volume of fluid or a volume connected thereto has a pressure-relief valve (25).

20. The accessory as claimed in claim 15, wherein the volume of fluid is connected via a line (19) to a fluid source.

21. The accessory as claimed in claim 20, wherein the fluid source is an air pump.

22. The accessory as claimed in claim 20, wherein the fluid source or a volume connected thereto has an actuatable outlet valve (22) and/or a pressure display (24).

23. The accessory as claimed in claim 15, wherein the fluid source is arranged on or incorporated into the return means (18).

24. The accessory as claimed in claim 15, further comprising a remote control (39) for the fluid source.

25. The accessory as claimed in claim 15, further comprising an air pump (36) arranged on or incorporated into the return means (18) as a fluid source, and an electrical drive (37) and a radio receiver for receiving signals for the activation of the air pump drive.

26. An accessory for a motor vehicle with an accelerator pedal (11), comprising:
a) fasteners or retainers for locating the accessory in a footwell of the motor vehicle, between the accelerator pedal and the footwell wall or a floor pan (14); and
b) and adjustable return means (18) for the accelerator pedal (11), the adjustable return means (18) being provided in addition to a return means (16) that is ordinarily associated with the accelerator pedal.

27. The accessory as claimed in claim 26, wherein a return force of the return means (18) is adjustable.

28. The accessory as claimed in claim 26, wherein the return means (18) is operative only over a part of the actuating travel of the accelerator pedal (11).

29. A foot mat (49) for a motor vehicle with an accelerator pedal, comprising a return means (18) for the accelerator pedal.

30. The foot mat as claimed in claim 29, wherein the return means (18) is elastically deformable.

31. The foot mat as claimed in claim 29, wherein the return means (18) contains a fluid-filled cushion.

32. The motor vehicle as claimed in claim 5, wherein the volume of fluid is a compressible volume of gas.

33. The motor vehicle as claimed in claim 6, wherein the volume of fluid is a compressible volume of gas.

34. The motor vehicle as claimed in claim 9, wherein the fluid source is a gas source.

35. The accessory as claimed in claim 14, wherein the fasteners or retainers for locating the adjustable return means (18) in a space behind the accelerator pedal (11) are located on the accelerator pedal (11).

36. The accessory as claimed in claim 16, wherein the fluid is a gas.

37. The accessory as claimed in claim 24, wherein the remote control is selected from the group consisting of radio and cable remote controls.
